(19) United States
(12) Patent Application Publication
(10) Pub. No.: US 2003/0008712 A1
(43) Pub. Date: Jan. 9, 2003

(54) System and method for distributing a multi-client game/application over a communications network

(75) Inventor: Martin Poulin, Bedford, TX (US)

Correspondence Address: DAVIS MUNCK, A PROFESSIONAL CORPORATION, 900 THREE GALLERIA TOWER, 13155 NOEL ROAD, DALLAS, TX, 75240, US

(73) Assignee: PLAYNET, INC., Bedford, TX

(21) Appl. No.: 10/162,438

(22) Filed: Jun. 4, 2002

Related U.S. Application Data
(60) Provisional application No. 60/295,874, filed on Jun. 4, 2001.

(51) Int. Cl. A63F 13/00

(52) U.S. Cl. 463/42

(57) ABSTRACT

An apparatus and method for distributing a multi-client system (10) over a communications network (40) for use in games and other applications. The system (10) includes a plurality of servers 14, 16, 18) each associated with one or more clients (32, 34, 36, 38). A set of data (102, 112, 122) is maintained on each server for each client/object, and an interaction data set for each non-associated client/object (clients/objects on another server) (104, 106, 114, 116, 124, 126) is transmitted to other servers to provide inter-server mirroring or duplication of data. The interaction data set is a subset of the set of data for each client/object. Volumes, each defined by a set of coordinates, managed by each server (204) are dynamically allocated to manage server load based upon the number of clients/users associated with the volumes.

### CROSS-REFERENCE TO RELATED APPLICATIONS

This application claims priority to United States provisional application No. 60/295,874 filed on Jun. 4, 2001, and which is hereby incorporated by reference.

### TECHNICAL FIELD OF THE INVENTION

The present invention relates to distributed computer systems and, in particular, to a method and apparatus for communicating and interacting within a distributed gaming/simulation system.

### BACKGROUND OF THE INVENTION

Massively Multiplayer Online Games (MMOG) are computer games played by a large number of users through a communications network, such as an ethernet, intranet or internet. The players interact with each other as determined by the specific game. Current MMOGs have two limitations: only a limited number of players can interact simultaneously and the size of the world in which they interact is limited. In addition, large simulations and simulation systems have similar limitations (some or all of the problems described below also may apply to simulations).

For three dimensional multiplayer action games, positional, status and event information for every player and object involved is transmitted or relayed to every other player playing the game. As the number of players increases, so does the amount of information that must be transmitted or relayed to each player. However, each player has a limited bandwidth available on his/her connection (network, Internet). Accordingly, this generally limits the number of players to a small number (e.g., 16 to 32).

Certain MMOG games reduce this amount of information by only transmitting information about a predetermined number of players that are closest to a player (e.g., 32 to 64 closest players). As more players are added to the game, the amount of bandwidth (information) to each player remains constant, but the amount of processing for the server increases. At a certain point, the server runs out of processing power to serve the players currently attached, and no other players may play the game (e.g. typically around 200 to 300 players).

In order to increase the number of players, some prior art systems utilized additional servers. Unfortunately, each server only had access to information about the players attached to that server. In essence, each server was a self-contained world with little or no interaction among the other servers. These systems used a system called “shards” wherein each server managed the players for a fixed geographic region. As a player traveled from region to region, the player was handed off (or transferred) from one shard (server; world) to the next.

The problem with a shard system is that each server is only manages its own independent region or world. For example, when the maximum number of players on one shard (one region) is exceeded no more players may enter that geographic region. Accordingly, the players are still restricted to interacting with the maximum players associated with a specific shard (server). To solve this problem, each region handled by a shard is reduced in size such that most of the time the number of players on the shard will not reach the maximum. This has two problematic side effects. First, since each server can only serve a small geographic region, the cost to model larger worlds (regions) is high (i.e., each small region requires its own dedicated server regardless of load). Second, to be cost effective, each shard should service more area than will hold the maximum number of players the shard serves. In other words, a shard must still have a method of limiting the number of players within its served region.

Accordingly, there exists a need for a gaming system and method that overcomes the problems with the prior art systems. A need exists for a realistic online game environment where large numbers of players can interact when and where the game dictates in regions that accurately model a real experience, and where a significant number of simultaneous players may play in a seamless geographic independent system that is distributed.

### SUMMARY OF THE INVENTION

According to the present invention, there is provided a distributed system having a first server operable for communicating with a first client. The first server maintains a data set relating to the first client. A second server operable for communicating with a second client maintains a data set including a set of data relating to the second client and at least a portion of the set of data relating to the first client. The portion of the set of data relating to the first client is received from the first server and communicated from the second server to the second client.

In another embodiment of the invention, there is provided a distributed system having a server operable for communicating with a plurality of clients. Each of the clients is positioned within a physical volume managed by the server. The server maintains a plurality of data sets having information about each one of clients. The server transmits to a first client the data sets associated with a predetermined number (fixed or dynamic) of the other clients that are interacting with the first client. The predetermined number of other clients is based upon a priority.

In yet another embodiment of the present invention, there is provided a method of inter-server mirroring of client information in a distributed system. The method includes communicating with a first client via a communications network and receiving at a first server, a first set of data relating to the first client. A second server communicate with a second client via a communications network and receive a first set of data relating to the second client. At least a portion of the first set of data relating to the first client is transmitted from the first server to the second server and stored. The second server then transmits to the second client the at least a portion of the first set of data relating to the first client.

The present invention also provides a method of dynamically distributing servers within a distributed server system. A first volume defined by a first set of coordinates is distributed for management to a first server. In response to an increase or decrease in a number of users associated with the first volume, the first volume managed by the first server is replaced with a second volume defined by a second set of coordinates different from the first set of coordinates.

Before undertaking the DETAILED DESCRIPTION OF THE INVENTION below, it may be advantageous to set forth definitions of certain words and phrases used throughout this patent document: the terms “include”, and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a distributed system 10 in accordance with the one embodiment of the present invention;

FIG. 2 is a diagram illustrating data sets associated with the servers shown in FIGURE;

FIG. 3 provides another embodiment of the present invention and illustrates volumes associated with servers;

FIGS. 4A, 4B, 4C and 4D illustrate different embodiments of dynamically distributing or allocating a particular volume between servers shown in FIG. 3; and

FIG. 5 illustrates core and boundary volumes associated with two of the servers (volumes B and E) shown in FIG. 3.

### DETAILED DESCRIPTION OF THE INVENTION

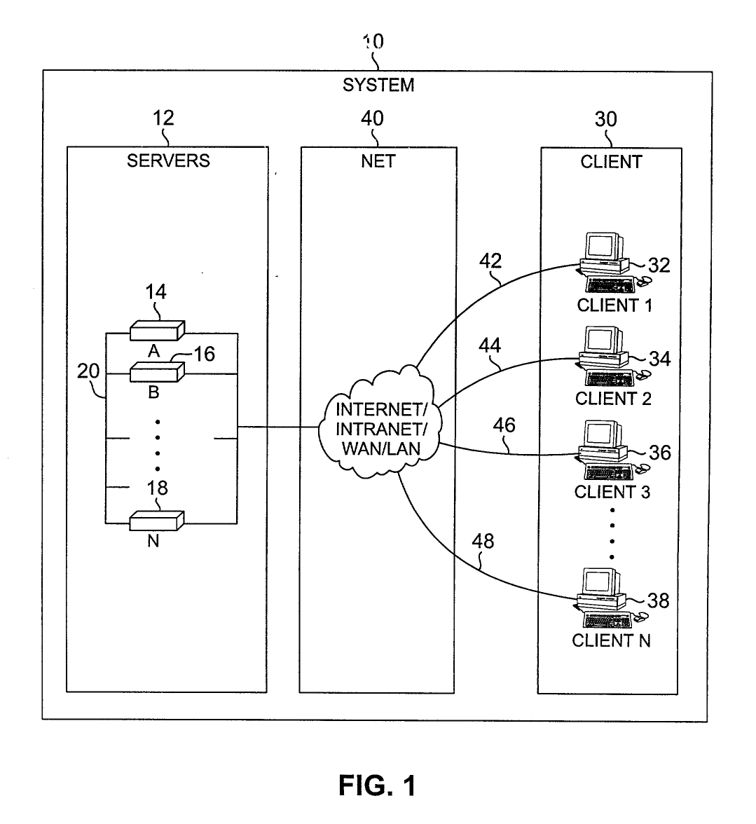

Now referring to FIG. 1, there is shown a distributed system 10 in accordance with the one embodiment of the present invention. The system 10 includes a server platform 12 and a client (or player) platform 30. The server platform 12 includes a plurality N of distributed servers 14, 16, 18. The client platform 30 includes a plurality X of clients 32, 34, 36, 38. The number X of clients is virtually limitless, and the present invention contemplates upwards of hundreds of thousands, to perhaps millions of clients. As will be appreciated, the system 10 is a distributed virtual environment and one such implementation is for a type of game generally known as massively multiplayer online game (MMOG) Another implementation is a distributed real time simulation. Accordingly, the description herein of the present invention is generally described with reference to a gaming system, but is similarly utilized and/or adapted in a distributed real time simulation. The term game or gaming may also refer to simulation or simulating.

Each of the clients 32, 34, 36, 38 generally includes a computer having a client software portion of the virtual environment for operation/interaction by the player within the distributed virtual environment system 10. The client is generally responsible for displaying interacting objects (other clients/players, terrain, etc.), displaying the user interface, processing user inputs, modeling user interactions and performing other CPU or bandwidth intensive operations that may be processed locally rather than done on the server. Each of the servers 14, 16, 18 generally includes a computer system having a server platform portion of the game for communication, database storage, coordination, and overall control and administration of the game. The servers generally maintain state information and coordinate client interaction with various objects in the virtual environment, including but not limited to other clients, vehicles, AI, terrain, and buildings. The server provides additional functions, such as security, recording training/gaming-goals and scoring, or the client advancement towards those goals.

The clients 32, 34, 36, 38 communicate with the server platform 12 via a communication network 40. In one embodiment, the communication network 40 is the internet, but in other embodiments the network 40 could be an intranet, WAN or LAN, or some other type of network utilized for communicating between the server platform and the client platform (the clients). Each client 32, 34, 36, 38 has an associated communications link (or session) with one of the servers 14, 16, 18. As shown in FIG. 1, the client 32 communicates with the server 14 via a communications link 42. Similarly, the client 34 communicates with the server 16 via a communications link 44; the client 36 communicates with the server 18 via a communications link 46; and the client 38 communicates with the server 14 via a communications link 48. The servers 14, 16, 18 are interconnected via a communications network 20. In the particular embodiment shown in FIG. 1, the communications network 20 is a dedicated network, but could also be a shared network, such as the Internet.

During operation of the system 10, a particular client 32, 34, 36, 38 desiring to enter the game communicates with the server platform 12 through a communications link 42, 44, 46, 48 with an allocated server 14, 16, 18. The determination of which specific server 14, 16, 18 a particular client is linked with will depend on one or a number of parameters, such as server load, number of clients, location of clients, status of client (e.g., position) within the game itself, and other parameters as may be known to those skilled in the art. In the particular embodiment shown in FIG. 1, the number of servers 14, 16, 18 needed for allocation depends on the number of clients. For example, if each server is capable of handling a predetermined number of clients, then the first clients up to this number will be allocated/linked with a first server, such as the server 14. When the number of clients increases above the server load, then a second server 16 is allocated by the system 10 to begin operation and accepting clients. FIG. 1 illustrates operation of the system 10 when a large number of clients 32, 34, 36, 38 are logged on and a plurality of servers 14, 16, 18 are utilized with each client as allocated/linked.

A controller or load managing server (not shown in FIG. 1) functions to allocate servers and connections with the clients 32, 34, 36, 38. As will be appreciated, initial connection between a client logging into the system 10 may be made with the controller or load managing server. Thereafter, based upon the allocation, client hand-off would occur to the selected/allocated server. Alternatively, one of the servers may perform the load managing or allocation function as well as the standard functions of a game server.

When there are relatively few clients participating in the game, generally only one server is needed to serve the clients. During game operation, there is no need for direct communication between clients. For 3D action games whereby clients interact with each other, each client needs positional, status and event information/data (referred to as client or player information, or as attributes) for every other client and/or object the client can see or interact with in the game grid/map. Such positional, status and event information includes, but is not limited to, type, physics/collision modeling, interaction rules data, scoring, position, orientation, motion vector, animation, vehicle, call sign, or other client or object attributes necessary for the particular application. Typically, the server includes a data set or database of information that is maintained and updated as the clients interact within the game. With a small number of clients (with small number of clients on a single server or a few servers), the data transfer from the server to each client is manageable. However, as the number of clients increase, so does the amount of information/data to be transferred to each client. In order to handle larger numbers of clients, prior art systems limited the data transfer to a particular client by only transmitting information/data on a certain number of clients or objects closest to the particular client. When only one server is utilized due to a small number of clients, the server maintains the positional, status and event information/data database for all clients on the server, and transfers updates to each client when required. When the number of clients increases, the number of servers allocated also increases; however, each server only maintains a database for the particular clients attached/linked to the server.

In order to allow more clients/players to play, prior art systems utilize additional servers. Unfortunately, each server only has the information on the clients attached to it and the objects associated with that particular server. In effect, each server is considered a self-contained world. In order to handle this issue, the prior art utilized systems called shards where each server manages the clients for fixed geographic regions. As clients travel from region to region they are handed off from one shard (server) to the next. The basic problem with shards is that each server is managing its own independent world without interaction with the other regions, and other limitations. For instance if the number of clients on one shard (one region) is exceeded, no more clients can enter that geographic region. In effect, the problem is that each client is still restricted to interacting with the maximum clients on that particular server (in that regions).

In attempting to address this problem, prior art systems developed a system whereby each region handled by a shard is made small enough such that there is a low probability that the number of clients on the particular shard will exceed the maximum number of clients allowed on the shard. This causes two problems—(1) for games encompassing large regions, for example, countries, continents or world, a large number of servers is required, and (2) to be cost effective, each shard must still service more area than will hold the maximum number of clients it will serve (in other words, a shard must have a method of limiting the number of clients within its served region).

These limitations are undesirable in applications/systems encompassing large regions (e.g. a continent, planet or even universe), where the basis of the application/system is to create an environment where large number of clients interact when and where the clients dictate. To overcome these limitations, the present invention provides a method and apparatus that supports a large number of simultaneous clients in a seamless geographic independent system. Thus, the present invention provides a distributed virtual environment.

When the number of clients exists such that a plurality of servers 14, 16, 18 are utilized in the system 10, the present invention provides for the inter-server mirroring of an interaction data set for each client 32, 34, 36, 38 (and objects) within the system 10 which is a subset of the overall positional, status and event information/data for each client 32, 34, 36, 38 and any objects associated with the server.

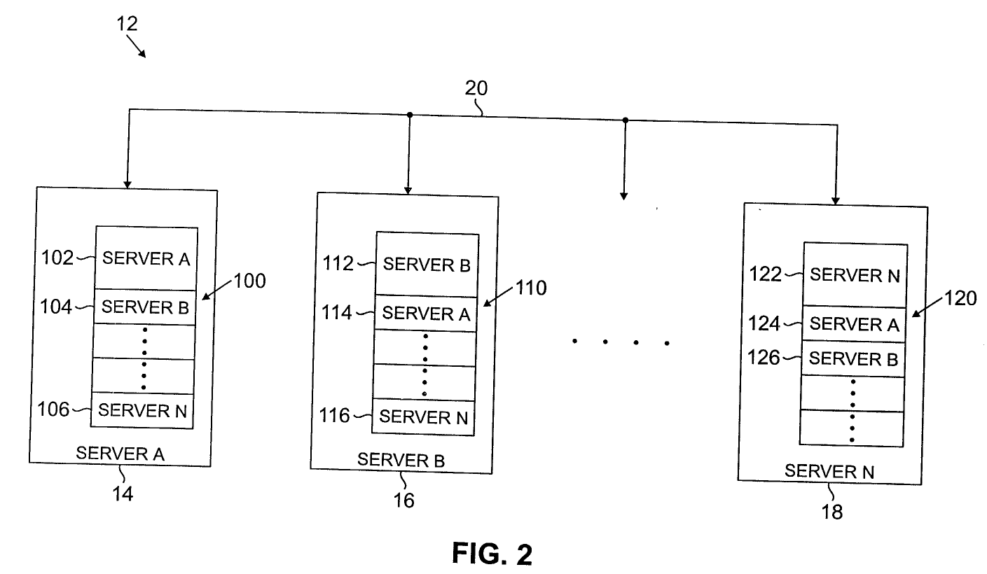

Now referring to FIG. 2, there is illustrated the server 14 (Server A) having a data set 100, the server 16 (Server B) having a data set 120, and the server 18 (Server N) having a data set 130. The data set 100 includes a plurality of data sets 102, 104, 106 that include data corresponding to each client attached/linked/playing the system 10. Other data sets, such as for objects, are also provided in the data set 100. The data set 102 includes the positional, status and event information/data for each particular client attached/linked to the server 14 (Server A) and for each object associated with server 14. The data set 104 includes a subset data of the positional, status and event information/data for each particular client attached/linked to the server 16 (Server B) and for objects associated with the server 16, while the data set 106 includes a subset data of the positional, status and event information/data for each particular client attached/linked to the server 18 (Server N) and for objects associated with the server 18. As will be appreciated, additional servers may be used in the server platform 12, and for each server, a subset of data of the positional, status event information/data for those particular clients attached/linked to the server, and those objects associated with the server, will be included in the data set 100.

Similarly, the data set 110 of the server 16 (Server B) includes a plurality of data sets 112, 114, 116 that include data corresponding to each client attached/linked/playing the system 10. Other data sets, such as for objects, are also provided in the data set 110. The data set 112 includes the positional, status and event information/data (attributes) for each particular client attached/linked to the server 16 (Server B) and for each object associated with server 16. The data set 114 includes a subset data of the positional, status and event information/data for each particular client attached/linked to the server 14 (Server A) and for each object associated with server 14, while the data set 116 includes a subset data of the positional, status and event information/data for each particular client attached/linked to the server 18 (Server N) and for each object associated with server 18.

Likewise, the data set 120 of the server 18 (Server N) includes a plurality of data sets 122, 124, 126 that include data corresponding to each client attached/linked/playing the system 10. Other data sets, such as for objects, are also provided in the data set 120. The data set 122 includes the positional, status and event information/data for each particular client attached/linked to the server 18 (Server N) and for each object associated with server 18. The data set 124 includes a subset data of the positional, status and event information/data for each particular client attached/linked to the server 14 (Server A) and for each object associated with server 14, while the data set 126 includes a subset data of the positional, status and event information/data for each particular client attached/linked to the server 16 (Server B) and for each object associated with server 16.

In other words, the data sets 100, 110 and 120 corresponding to the servers 14, 16, 18 include the positional, status and event information/data for each client attached/linked to that particular server and for each object associated with server. The data sets also include an interaction subset of data (of the positional, status and event information/data) for each client attached/linked to all the other servers, and for each object associated with all the other servers. This provides an inter-server mirror of an interaction subset of data about each client (and object).

As will be appreciated, in one embodiment of the present invention, the full positional, status and event information/data for each client and each object is mirrored (or duplicated) across the servers. In another embodiment, the interaction subset of data for each client and each object is mirrored (or duplicated across the servers.

The interaction subset of data is generally the minimum amount of data needed to interact with other clients or other servers. This data is generally the data necessary/important and specific to the particular client sufficient to allow interaction with other clients and objects. Data such as client/object type, distance, or other attributes depending on the functionality of the system as needed and desired by those practicing the invention may be included in the interaction data. With mirrored (or partially mirrored) data, each server includes all the important information for all the clients and objects, but only manages the connections and update loops of the clients attached to that particular server.

As will be appreciated, the positional, status and event information/data (attributes), as well as the subset of data, may not only exist for each client, but may also exist for, or relate to, a particular object within the system, and not only attributes of a client (player). For example, a group of clients may be combined to become an object (such as a tank or ship, etc.), or a specific object within the game may interact (such as a mountain, river, etc.).

The data sets of subset data 104, 106, 114, 116, 124, 126 are updated and communicated on a regular basis through the network 20. In one embodiment, each interaction subset of data for clients and/or objects associated with a particular server 14, 16, 18 is communicated via direct (single cast) connection to the other servers or through a broadcast/multicast method. Direct or single cast describes a simple communication system dedicated between two endpoints for sharing information just between those two endpoints. Broadcast or multicast describes a method of sending information to multiple endpoints at the same time.

During operation, each server 14, 16, 18 transmits to the associated attached clients 32, 34, 36, 38 either the full client and/or object information or the subset of data associated with all clients and/or objects, or only those clients and/or objects that are, or will be, “interacting” with the particular client. In the case of an interacting client (or interacting object) attached to the same server as the client, then the server operably transmits either the full information or the subset of data associated with the interacting clients and/or objects. In the case of an interacting client (or interacting object) attached to a different server, then the server operably transmits the subset of data associated with the interacting clients and/or objects. The transfer of this data, of course, depends on the determination that the client/object is an “interacting” client/object. If another client/object falls within an “interaction zone” of the client, then the other client/object is an “interacting” client. The interaction zone is generally distance related, but may also be related to the attributes of client or object (e.g., infantry, tank, aircraft, etc.). Accordingly, the specific attributes and distance of other clients/objects (and upon which server the client is attached) determine whether the clients/objects are “interacting” clients such that the associated server transmits the full information (or subset of data) to the client.

For example, in the case of the client 32, the server 14 will transmit to the client 32 the information about all “interacting” clients/objects. If the client 34 is determined to be an interacting client (i.e., the client 34 is interacting with the client 32 within an interaction zone in the game), the server 14 transmits to the client 32 the subset of data associated with the client 34. Similarly, information about interacting objects will also be transmitted.

When a large number of clients/objects interact with a particular client, the present invention also provides a method of prioritizing the interacting clients/objects data (i.e., certain interacting clients/objects within the interaction zone are more important to the client) and transmitting such data to the client based upon priority. Not only is the interaction zone determined for a particular client/object, but the interacting clients within that zone may also be prioritized (from the viewpoint of the client). Prioritization may be necessary due to the large amounts of data that would be transmitted to the client resulting from a large number of interacting clients/objects or the client's ability to interact with that data. In accordance with the present invention, prioritization is generally based upon distance, the attributes of the client, and the attributes of the interacting client/objects. Such attributes include, but are not limited to, object size (e.g., a small object may not provide interaction or be perceived by the client at some predetermined distance), allegiance (e.g., client more interested in seeing/interacting with enemies than friendly companions in a battle), the classification of object (e.g., an aircraft bomber is more concerned with enemy aircraft fighters than enemy tanks), relationship (e.g., aircraft fighters are only interested in infantry if they are below 500 feet for attack). As will be appreciated, the specific attributes and prioritization will depend on the desired game/application.

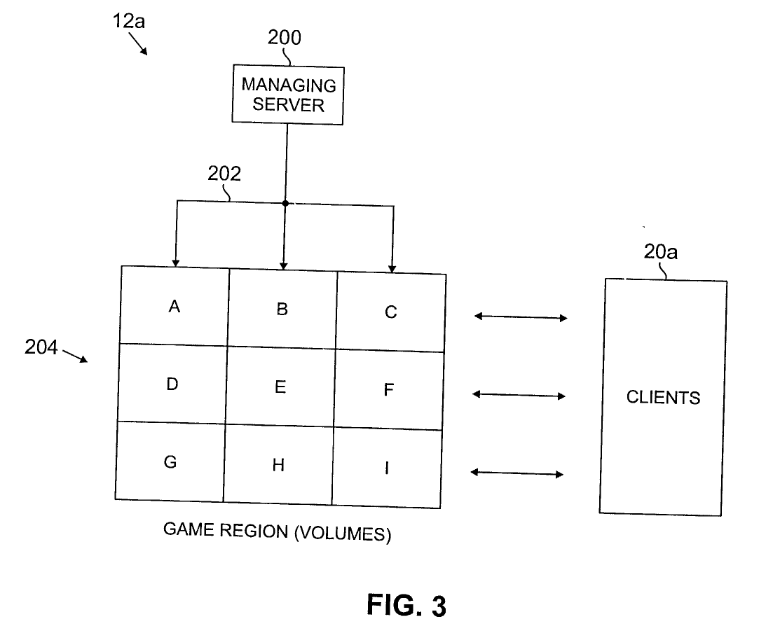

Now referring to FIG. 3, there is shown another embodiment of the system 10 with a server platform 12a. The server platform 12a includes a managing server 200 and a plurality of servers 204 (designated using reference letters A thru I) interconnected via a communications network 202. The number of servers 203 may be more or less than the number shown. In the particular embodiment shown in FIG. 3, the communications network 202 is a dedicated network, but could also be a shared network, such as the Internet. The client platform 20a is similar to that described above and will generally include numerous clients (and objects) each with a connection/links/session to a server within the server platform 12a. In addition, the server platform 12a includes a communications network interconnecting each of the servers 203 (A-I) similar in nature to the communications network 20 illustrated in FIGS. 1 and 2.

Conceptually, the plurality of servers A-I represents a grid or map system whereby each server is associated with a specific map, grid or terrain, referred to as geographic regions. As will be appreciated by those skilled in the art, the specific representation shown in FIG. 3 is two dimensional, but applies similarly to three-dimensional regions, but for ease of description use of two-dimensional regions (as shown in FIG. 3) shall be used. Accordingly, the term “volume” shall be used hereafter to describe any dimensional geographic region (1D, 2D, 3D, 4D, etc.). Generally, gaming systems that serve a 3D action game are usually configured to distribute clients and information within a volume. Server load within a volume is monitored, as load peaks (number of clients), volumes are dynamically allocated to another server or servers and the clients (and objects) in those volumes are transferred to the other server(s) seamlessly. In other words, volumes associated with specific servers will dynamically increase or decrease depending on load.

The managing server 200 distributes and assigns volumes to the servers 204 (A-I). Any volume may be assigned to any server. While advantageous to assign volumes to be contiguous, contiguous volumes are not necessary. Each volume is defined by a set of coordinates. The servers 204 (A-I) that have few or no clients are typically assigned a large volume, or a large numbers of unassigned volumes, for management. As will be appreciated, the managing server may include one or more interconnected servers. The managing server 200 transmits sets of coordinates to each server A-I describing the volume that each server will manage. As a server is allocated new volumes to service, the server loads the new volume and strategic information (transferred from the managing server or loaded from an information database).

In general operation, to enter the game, a client contacts an authentication server (not shown, via some address). The authentication server verifies client identification and creates a client persona (with player id) for recognition throughout the server platform 12a. The client persona includes data associated therewith including permissions and mission information. Once created, the client is presented with a map interface, selects a source country, and several theaters on the map are highlighted from which to select. Depending on the selection (geographic, volume), the client is then handed off to the appropriate server associated with that volume. Alternatively, a missions/map server may be utilized to perform one or some of the functions described. As will be appreciated, the client could initially communicate with any of the servers within the platform, and then be directed or handed-off to the appropriate server.

Described below is the method, in accordance with the present invention, for managing load by dynamic distribution of volumes to servers. Instead of fixed volumes assigned to specific servers, volumes are dynamically assigned or distributed to servers based upon load. Instead of having a client move from one volume to another to manage server load, the volume is segmented and the volume moves to another server. As will be appreciated, the volumes associated with particular servers may be initially fixed, but then dynamically assigned based upon load, or may be dynamically assigned from the beginning.

With continued reference to FIG. 3, let us assume that the servers 204 each have a specific volume associated with each server, and that the volumes and servers are identified as volumes A-I. As will be appreciated, the volumes A-I may be different sizes and shapes. Each volume A-I represents a geographic region within the game, and a specific number of clients/objects are associated with each volume (positioned within that region of the game). Directing attention to volume E, let us assume that new clients are entering the game in volume E, or clients are congregating in volume E (i.e., the battle is converging in region E, for some reason). As the number of clients in volume E increases, the server load increases. At some point, the server load will increase and processing will suffer thus degrading the game. At this point, in prior art systems, no additional clients would be allowed to enter volume E.

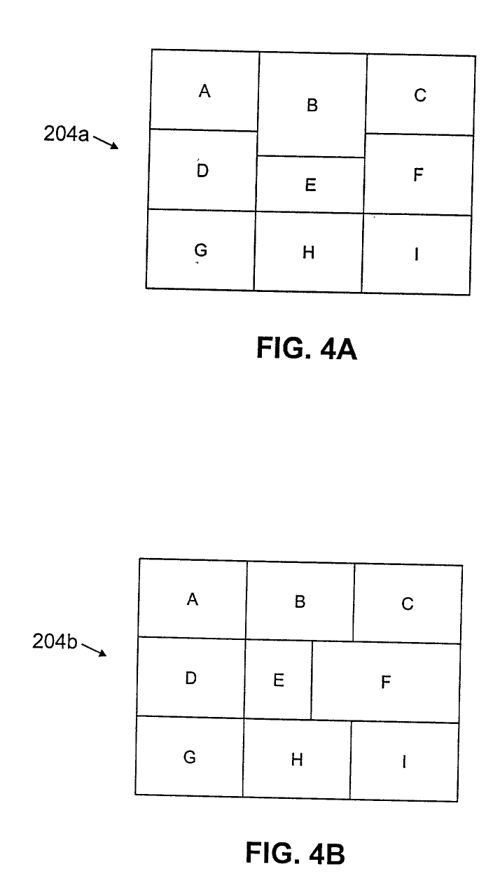

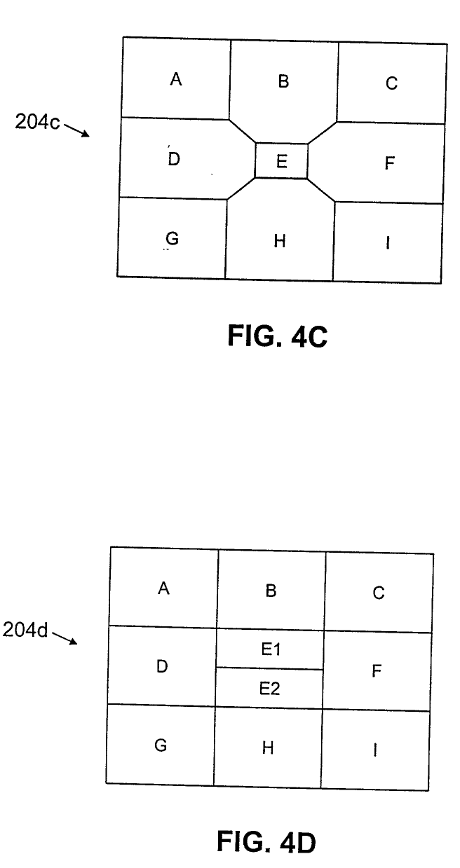

However, in accordance with the present invention, the volume E is partitioned or allocated (increased/decreased in size) and dynamically distributed to other servers in order to handle the load. With reference to FIGS. 4A, 4B, 4C, and 4D, there are shown several possible allocations of volume E depending on the server load in the surrounding volumes. In FIG. 4A, the volume E is decreased while the volume B is increased. In FIG. 4B, the volume E is decreased while the volume F is increased. In FIG. 4C, the volume E is decreased while the volumes B, D, F, and H are increased. In FIG. 4D, the volumes E is divided into two new volumes E1 and E2, with a new server introduced. In order to prevent continual dynamic distributions when clients enter or leave the game, or move within the game, the present invention includes hysteresis. The hysteresis function can be programmed in accordance with the desired characteristics by those skilled in the art. It will be understood that the volumes (or server load) resulting from the dynamic distribution or allocation may generally be any size or shape. While the FIGS. 4A-4D illustrate dynamically distribution or allocation of volumes in response to an increase in clients (particularly in volume E), the present invention includes the dynamic distribution or allocation in response to a decrease in clients (in a particular volume or volumes). According to the present invention, volumes are segmented but the client(s) is allowed to stay in the same volume (or space/position within the game).

Upon a dynamic distribution or allocation, any clients (and objects) positioned in a new volume served by a different server are transferred to the new server. Upon dynamic distribution of the volumes, the identity of those client(s) whose volumes have changed (i.e., the client is now in a new volume served by a different server) is determined. When determined, the sending server sends a client transfer request to the receiving server. The request includes all client information. When the transfer request is received, the new server adds the client to the client index hash and sends an acknowledgment. Upon receipt of the acknowledgment, the old server instructs the client's application program to make a new connection to the new server, and also transmits a handshake to the new server. The client's application then closes the connection to the old server.

In addition to dynamically distributing or allocating volumes to servers to manage load, the present invention segments data into core and boundary volumes to determine the data to be shared and transmitted between volumes (i.e., servers). In addition, the present invention also provides for dynamic allocation/determination of the boundary volumes between volumes. The boundary volume is determined by the interaction overlap volume between volumes (similar to the interaction zone, as described above, for determining interacting clients/objects). While the maximum overlap volume is dictated by the maximum interaction distance between any two objects (client/client, client/object, object/object) contained on the servers, the actual objects mirrored may also be limited by their own maximum interaction distance (e.g. small or camouflaged objects may have much smaller interaction distances).

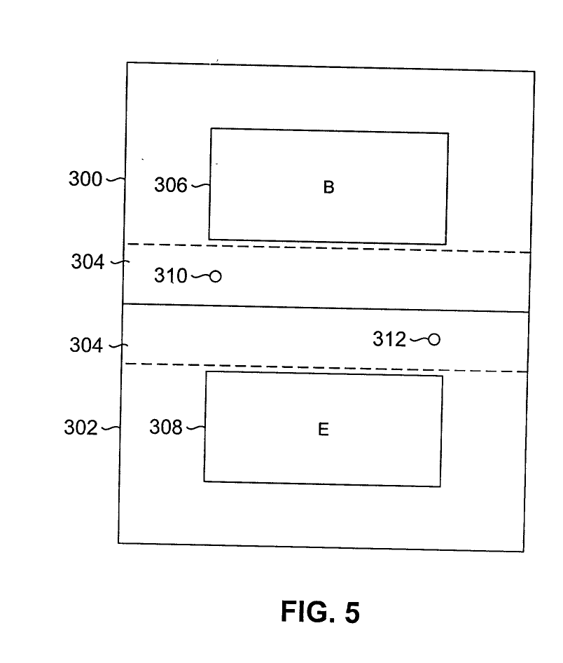

Now referring to FIG. 5, there are illustrated core and boundary volumes associated with two of the servers 204 (volumes B and E) shown in FIG. 3. The server 300 (volume B) includes a core boundary 306 and a portion of a boundary volume 304. The server 302 (volume E) includes a core boundary 308 and a portion of the boundary volume 304. As illustrated, the boundary volume 304 comprises the volume bounded by the dotted lines (see FIG. 5), and is also called the interaction overlap volume.

Server 300 maintains full information for each object and for each client attached (positioned within volume B) to the server 300 while server 302 maintains full information of each object and for each client attached (positioned within volume E) to the server 302. The client/object data for each server is segmented based upon the position of the client within the server volume (e.g. core or boundary volumes). This is accomplished to allow each server to identify those clients whose data requires transmission to the adjacent server(s). In one embodiment, the client data transmitted between volumes is the full client/object information, and in another embodiment, the client/object data transmitted is only a subset of the full information (as described earlier). For example, client data for a client 310 positioned in volume B and within the boundary volume 304 is transmitted to the server 302 (volume E). Similarly, client data for a client 312 positioned in volume B and within the boundary volume 304 is transmitted to the server 300 (volume B).

In one embodiment of the present invention, the size and shape of the interaction overlap volume between adjacent volumes is fixed at a predetermined distance from the regular boundaries of the volumes. In another embodiment, the interaction overlap volume is dynamically distributed or allocated based upon server load and/or number of clients in a given volume. Moreover, the boundary volume or interaction overlap volume may be different in size or different objects (clients/objects). Generally, the maximum interaction volumes (between volumes) defines the core volumes within each volume (server).

Additionally, previously described prioritization methods may also be utilized with respect to clients/objects positioned within the boundary volumes. As will be appreciated, other servers (volumes) in addition to the servers (volumes) shown in FIG. 5 may be utilized, and between adjacent volumes exists overlapping boundary volumes.

It will be understood that any number of the servers 203 (A-I) illustrated in FIGS. 3 and 5 may each include a plurality of servers (not shown). In such a configuration, the plurality of servers associated with a specific volume is referred to as a cluster, and multiple clusters may exist. In addition, multiple clusters may exist with individual servers interspersed within or throughout the map region. A cluster may represent a relatively large volume (such as a country or continent) and may be managed by a separate cluster-managing server (not shown), in essence creating a virtual LAN within the system 10. As will be appreciated, any and all details of the present invention as described above, and described with respect to a server or servers, are applicable to, and may be used with, a cluster or cluster architecture.

Although the present invention and its advantages have been described in the foregoing detailed description and illustrated in the accompanying drawings, it will be understood by those skilled in the art that the invention is not limited to the embodiment(s) disclosed but is capable of numerous rearrangements, substitutions and modifications without departing from the spirit and scope of the invention as defined by the appended claims.

What is claimed is:

1. A distributed gaming system, comprising:
a first server operable for communicating with at least a first player, the first server having a data set comprising,
a set of data relating to the first player; and
a second server operable for communicating with at least a second player, the second server having a data set comprising,
a set of data relating to the second player, and
at least a portion of the set of data relating to the first player, the at least a portion of the set of data relating to the first player received from the first server and for communication from the second server to the second player.

2. A gaming system in accordance with claim 1 wherein the set of data relating to the first player and the set of data relating to the second player comprise positional, status and event information, and wherein the at least a portion of the set of data relating to the first player comprises a set of interaction data which is a subset of the positional, status and event information relating to the first player.

3. A distributed gaming system, comprising:
a server operable for communicating with a plurality of clients, each of the clients positioned within a physical volume managed by the server, the server further comprising,
a plurality of data sets, each data set comprising
information about each one of the plurality of clients, and wherein the server transmits to a first one of the plurality of clients the data sets associated with a predetermined number of other clients interacting with the first client, the predetermined number based upon priority.

4. A system in accordance with claim 3 wherein the priority is determined by one or more attributes of the other clients.

5. A system in accordance with claim 3 wherein the priority is determined by one or more attributes of the other clients and one or more attributes of the first client.

6. A method of inter-server mirroring of client information in a distributed system, comprising:
communicating with a first client via a communications network;
receiving at a first server, a first set of data relating to the first client;
communicating with a second client via a communications network;
receiving at a second server, a first set of data relating to the second client;
transmitting at least a portion of the first set of data relating to the first client from the first server to the second server and storing the data; and
transmitting from the second server to the second client, data relating to the first client.

7. A method in accordance with claim 6 further comprising
communicating with a third client via a communications network;
receiving at the first server, a first set of data relating to the third client;
transmitting at least a portion of the first set of data relating to the third client from the first server to the second server and storing the data; and
transmitting from the second server to the second client, data relating to the third client.

8. A method in accordance with claim 7 wherein the transmitting from the second server to the second client, data relating to the first client, and the transmitting from the second server to the second client, data relating to the first client, are prioritized based upon a predetermined set of priorities.

9. A method in accordance with claim 8 wherein the set of priorities comprises distance.

10. A method in accordance with claim 8 wherein the set of priorities comprises distance and one or more attributes of the first client and the third client.

11. A method in accordance with claim 6 wherein the clients are players within an online gaming system.

12. A method of dynamically distributing servers within a distributed server system, comprising:
distributing for management a first volume defined by a first set of coordinates to a first server; and
in response to an increase or decrease in a number of users associated with the first volume, replacing for management by the first server the first volume with a second volume defined by a second set of coordinates different from the first set of coordinates.

13. A method in accordance with claim 12 further comprising:
in response to an increase in the number of users associated with the first volume, distributing for management among at least one or more servers other than the first server, a third volume defined by a third set of coordinates and further defined as the remainder of the first volume not encompassed by the second volume.
